(19) United States
(12) Patent Application Publication
(10) Pub. No.: US 2010/0055564 A1
(43) Pub. Date: Mar. 4, 2010

(54) POROUS PROTECTIVE FILM LAYER-PROVIDED ELECTRODE, NON-AQUEOUS ELECTROLYTE SECONDARY BATTERY AND METHOD FOR MANUFACTURING POROUS PROTECTIVE FILM LAYER-PROVIDED ELECTRODE

(75) Inventors: Takashi Tokunaga, Fukushima (JP); Junichi Tadano, Fukushima (JP); Koichi Sasaki, Fukushima (JP)

Correspondence Address: K&L Gates LLP, P. O. BOX 1135, CHICAGO, IL, 60690, US

(73) Assignee: SONY CORPORATION, Tokyo (JP)

(21) Appl. No.: 12/547,171

(22) Filed: Aug. 25, 2009

(30) Foreign Application Priority Data
Aug. 26, 2008 (JP) 2008-216075

(51) Int. Cl. H01M 4/02; B05D 5/12

(52) U.S. Cl. 429/209; 427/58

(57) ABSTRACT

A porous protective film layer-provided electrode includes: an electrode is provided and having a collector and an electrode mixture layer disposed on the surface of the collector, the mixture layer containing an electrode active material and a first resin; and a porous protective film layer disposed on the surface of the electrode mixture layer, the film layer containing an inorganic filler and a second resin. A chemical bond including a structure represented by —O— or —O—Si— is present between the inorganic filler and the second resin.

### CROSS REFERENCES TO RELATED APPLICATIONS

The present application claims priority to Japanese Priority Patent Application JP 2008-216075 filed in the Japan Patent Office on Aug. 26, 2008, the entire contents of which is hereby incorporated by reference.

### BACKGROUND

In recent years, portable information electronic appliances such as mobile phones, video cameras and laptop personal computers have diffused, and it is devised to realize high performance, downsizing and weight saving of these electronic appliances.

Following this, it has been strongly demanded to realize a high energy density on batteries to be used for such electronic appliances. From the viewpoint of favorable comprehensive balance among economy, high performance, downsizing, weight saving and the like, research and development of a non-aqueous electrolyte secondary battery are eagerly carried out.

Examples of the foregoing non-aqueous electrolyte secondary battery include a non-aqueous electrolytic solution secondary battery using a carbon material as a negative electrode active material, a lithium cobalt complex oxide as a positive electrode active material and a solution having a lithium salt dissolved in a non-aqueous solvent as a non-aqueous electrolytic solution, respectively.

This secondary battery has such advantages that the battery voltage is high and that the self discharge is low and is able to realize a high energy density.

In order to actually use the foregoing carbon material and lithium complex oxide as active materials, these compounds are formed into powders having an average particle size of from 5 to 50 μm and dispersed in a solvent together with a binder to prepare a negative electrode mixture slurry and a positive electrode mixture slurry, respectively.

Each of the slurries is coated on a metal foil which will serve as each collector, thereby preparing a negative electrode active material layer and a positive electrode active material layer, respectively.

Furthermore, a negative electrode and a positive electrode prepared by forming the negative electrode active material layer and the positive electrode active material layer, respectively on the collector are partitioned from each other while mediating a separator therebetween and housed in a battery can in that state.

In such a non-aqueous electrolytic solution secondary battery, there is encountered a problem that a foreign matter which has been incorporated at the time of preparation, an active material which has again attached after falling off, or the like causes an internal short circuit.

Then, in order to solve the foregoing problem, it is proposed to provide a porous protective film prepared by coating a fine particle slurry containing a binder and a fine particle on the surface of any one of the negative electrode active material layer or the positive electrode active material layer and then drying (see, for example, JP-A-7-220759).

However, in the non-aqueous electrolytic solution secondary battery disclosed in the foregoing JP-A-7-220759, there was involved a problem that as the charge and discharge cycle proceeds, breakage or separation of the porous protective film occurs.

Thus, it is desirable to provide a porous protective film layer-provided electrode capable of suppressing or preventing the occurrence of breakage or separation of a porous protective film accompanying the progress of a charge and discharge cycle; a non-aqueous electrolyte secondary battery; and a method for manufacturing a porous protective film layer-provided electrode.

### SUMMARY

The present disclosure relates to a porous protective film layer-provided electrode, a non-electrolyte secondary battery and a method for manufacturing a porous protective film layer-provided electrode.

In detail, the present disclosure relates to a porous protective film layer-provided electrode including an electrode having an electrode mixture layer containing an electrode active material and a first resin and a porous protective film layer disposed on the surface of the electrode mixture layer and containing an inorganic filler and a second resin which are chemically bonded to each other; a non-aqueous electrolyte secondary battery; and a method for manufacturing a porous protective film layer-provided electrode.

In an embodiment coating a slurry containing an electrode active material and a first resin material on a collector and drying to form an electrode mixture layer and further coating a slurry containing an inorganic filler material and a second resin material thereon and drying to form a porous protective film layer is disclosed.

That is, according to an embodiment, there is provided a porous protective film layer-provided electrode including an electrode having a collector and an electrode mixture layer disposed on the surface of the collector, the mixture layer containing an electrode active material and a first resin; and a porous protective film layer disposed on the surface of the electrode mixture layer, the film layer containing an inorganic filler and a second resin.

The porous protective film layer-provided electrode according to the embodiment of the present invention has a chemical bond including a structure represented by the following general formula (1) or (2), which is formed between the inorganic filler and the second resin.

—O— (1)

—O—Si— (2)

Also, a non-aqueous electrolyte secondary battery according to an embodiment includes an electrode having a collector and an electrode mixture layer disposed on the surface of the collector, the mixture layer containing an electrode active material and a first resin; a porous protective film layer disposed on the surface of the electrode mixture layer, the film layer containing an inorganic filler and a second resin; a non-aqueous electrolyte; and a separator.

The non-aqueous electrolyte secondary battery according to the embodiment has a chemical bond including a structure represented by the following general formula (1) or (2), which is formed between the inorganic filler and the second resin.

—O— (1)

—O—Si— (2)

Furthermore, according to another embodiment, there is provided a first method for manufacturing a porous protective film layer-provided electrode including the steps of: (A1) coating a slurry for forming an electrode mixture layer containing an electrode active material and a first resin material on a collector and drying to form an electrode mixture layer or an electrode mixture layer precursor; and (A2) coating a slurry for forming a porous protective film layer containing an inorganic filler and a second resin material on the obtained electrode mixture layer or electrode mixture layer precursor and drying to form a porous protective film layer.

According to still another embodiment, there is provided a second method for manufacturing a porous protective film layer-provided electrode including the steps of: (B1) a coating a slurry for forming an electrode mixture layer containing an electrode active material and a first resin material on a collector and drying to form an electrode mixture layer or an electrode mixture layer precursor; and (B2) coating a slurry for forming a porous protective film layer containing an inorganic filler material, a second resin material and a silane coupling agent on the obtained electrode mixture layer or electrode mixture precursor and drying to form a porous protective film layer.

According to the embodiments, the slurry containing the electrode active material and the first resin material is coated on a collector and dried to form the electrode mixture layer, and the slurry containing the inorganic filler material and the second resin material is further coated thereon and dried to form a porous protective film layer, whereby it is possible to provide the porous protective film layer-provided electrode capable of suppressing or preventing the occurrence of breakage or separation of a porous protective film accompanying the progress of a charge and discharge cycle; the non-aqueous electrolyte secondary battery; and the method for manufacturing a porous protective film layer-provided electrode.

Additional features and advantages are described herein, and will be apparent from the following Detailed Description and the figures.

### BRIEF DESCRIPTION OF THE FIGURES

FIG. 1 is a diagrammatic sectional view showing an example of a configuration of a non-aqueous electrolyte secondary battery according to Embodiment 1.

FIG. 2 is a diagrammatic sectional view showing enlargedly a part of a wound electrode body shown in FIG. 1.

FIG. 3 is a diagrammatic sectional view showing enlargedly a part of a negative electrode shown in FIG. 1.

FIG. 4 is a perspective view showing an example of a configuration of a non-aqueous electrolyte secondary battery according to Embodiment 2.

FIG. 5 is a diagrammatic sectional view showing enlargedly a part of a wound electrode body shown in FIG. 4.

FIG. 6 is an SEM photograph of a porous protective film layer in Example 1.

FIG. 7 is an SEM photograph of a porous protective film layer in Comparative Example 2.

### DETAILED DESCRIPTION

Embodiments according to the present invention are hereunder described with reference to the accompanying drawings. In all of the drawings of the following embodiments, the same or corresponding portions are given the same symbols.

### (1) Embodiment 1

### (1-1) Configuration of Non-Aqueous Electrolyte Secondary Battery:

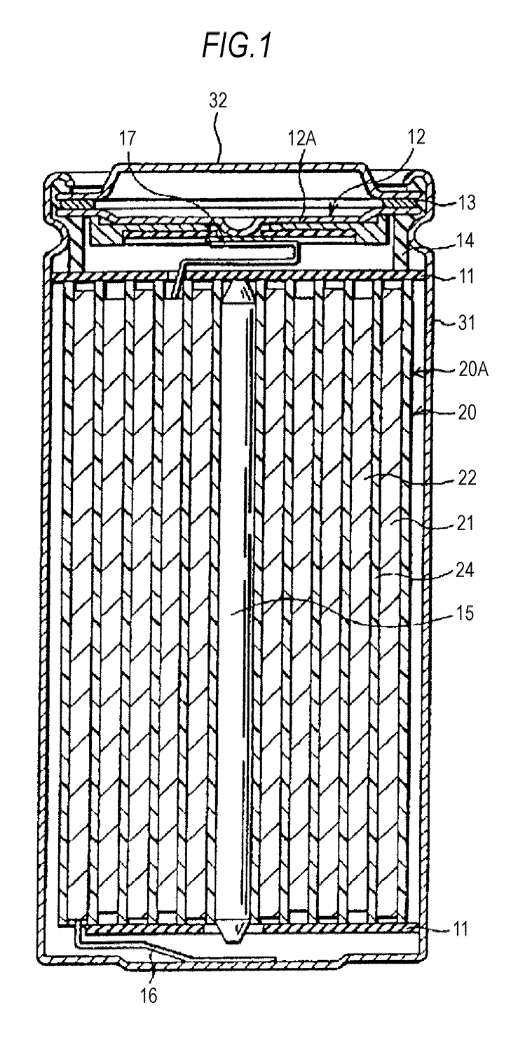

FIG. 1 is a diagrammatic sectional view showing an example of a configuration of a non-aqueous electrolyte secondary battery in Embodiment 1. This non-aqueous electrolyte secondary battery is of a so-called cylinder type.

As shown in FIG. 1, this non-aqueous electrolyte secondary battery is a part of an exterior member and has a wound electrode body 20 in the inside of a substantially hollow columnar battery can 31. The wound electrode body 20 is one in which a negative electrode 21 and a positive electrode 22 are located opposing to each other via a separator 24 and wound.

The separator 24 contains a non-aqueous electrolytic solution which is an example of a non-aqueous electrolyte. A combination of the wound electrode body 20 and the non-aqueous electrolyte is designated as a battery element 20A.

The battery can 31 is configured of, for example, iron (Fe) plated with nickel (Ni), and one end thereof is closed, with the other end being opened. In the inside of the battery can 31, a pair of insulating plates 11 is disposed vertically against the winding peripheral surface so as to interpose the wound electrode body 20 therebetween.

Also, in the open end of the battery can 31, a battery lid 32 which configures a part of the exterior member and a safety valve mechanism 12 and a positive temperature coefficient element (PTC element) 13 each provided on the inside of this battery lid 32 are installed by caulking via a sealing gasket 14, and the inside of the battery can 31 is hermetically sealed. The battery lid 32 is configured of, for example, a material the same as that in the battery can 31. The safety valve mechanism 12 is electrically connected to the battery lid 32 via the positive temperature coefficient element 13. In the case where the pressure in the inside of the battery reaches a fixed value or more due to an internal short circuit or heating from the outside or the like, a disc plate 12A is reversed, whereby electrical connection between the battery lid 32 and the wound electrode body 20 is disconnected. When the temperature rises, the positive temperature coefficient element 13 controls the current due to an increase of the resistance value, thereby preventing abnormal heat generation to be caused due to a large current. The positive temperature coefficient element 13 is configured of, for example, a barium titanate based semiconductor ceramic. The sealing gasket 14 is configured of, for example, an insulating material, and asphalt is coated on the surface thereof.

The wound electrode body 20 is, for example, wound around a center pin 15. A negative electrode lead 16 made of nickel or the like is connected to the negative electrode 21 of the wound electrode body 20, and a positive electrode lead 17 made of aluminum or the like is connected to the positive electrode 22. The negative electrode lead 16 is welded and electrically connected to the battery can 31, and the positive electrode lead 17 is welded to the safety valve mechanism 12 and electrically connected to the battery lid 32.

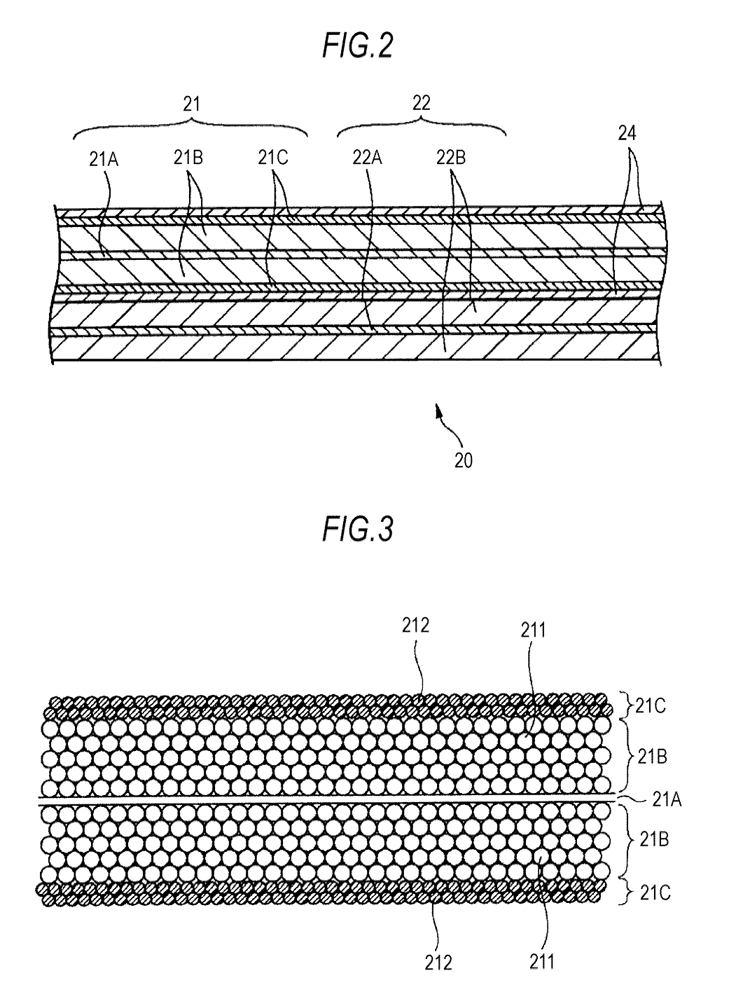

FIG. 2 shows enlargedly a part of the wound electrode body 20 shown in FIG. 1.

The negative electrode 21, the positive electrode 22, the separator 24 and the non-aqueous electrolyte, each of which configures a secondary battery, are hereunder described in success with reference to FIG. 2.

### (Negative Electrode)

The negative electrode 21 has, for example, a structure in which a negative electrode mixture layer 21B is provided on the both surfaces of a negative electrode collector 21A having a pair of opposing surfaces to each other. Also, a porous protective film layer 21C is provided on the surface of the negative electrode mixture layer 21B.

Though illustration is omitted, the negative electrode mixture layer 21B may be provided only on one surface of the negative electrode collector 21A.

The negative electrode collector 21A is configured of a metal foil, for example, a copper foil, etc.

Also, the negative electrode mixture layer 21B is configured to include a negative electrode active material and a first resin and may include a conductive agent, for example, vapor growth carbon fibers, etc. as the need arises.

Furthermore, the porous protective film layer 21C is configured to include an inorganic filler and a second resin and may include a surfactant, for example, sodium dodecyl sulfate, etc. as the need arises.

Here, examples of the negative electrode active material include a negative electrode material capable of intercalating and deintercalating lithium.

In this secondary battery, the electrochemical equivalent of the negative electrode material capable of intercalating and deintercalating lithium is larger than that of the positive electrode 22 so that a lithium metal is not deposited in the negative electrode 21 on the way of charge.

Examples of the negative electrode active material which can be used include carbon materials capable of intercalating and deintercalating lithium, crystalline metal oxides and amorphous metal oxides. Examples of the carbon material include hardly graphitized carbons (for example, cokes, vitreous carbons, etc.) and graphites of a highly crystalline carbon material having a developed crystal structure. Specific examples thereof include pyrolytic carbons, cokes (for example, pitch coke, needle coke, petroleum coke, etc.), graphite, vitreous carbons, polymer compound baked materials (for example, those obtained through carbonization by baking a phenol resin, a furan resin or the like at an appropriate temperature), carbon fibers and active carbon.

As the first resin, for example, a resin capable of binding the negative electrode active material can be applied. Examples of such a resin include fluorocarbon resins (for example, polyvinylidene fluoride, etc.); and mixtures of carboxymethyl cellulose and a rubbery resin (for example, a styrene butadiene rubber, an acrylic rubber, a butadiene rubber, an acrylonitrile butadiene rubber, etc.).

From the viewpoint of preventing a physical or chemical internal short circuit from occurring, for example, an insulating fine particle can be applied as the inorganic filler. Also, the inorganic filler is suitably a metal oxide from the viewpoint that it is more desirable that it is useful in the presence of a non-aqueous electrolyte and insoluble in a non-aqueous solvent.

Examples of such a metal oxide include silica, alumina and zirconia. These compounds may be used singly or in admixture.

From the viewpoint of suppressing or preventing the occurrence of breakage or separation of the porous protective film layer, it is desirable that a chemical bond including a structure represented by the following general formula (3) or (4) is formed between the first resin and the inorganic filler.

—O— (3)

—O—Si— (4)

The second resin has a chemical bond including a structure represented by the following general formula (1) or (2) between the second resin and the inorganic filler.

—O— (1)

—O—Si— (2)

The second resin is not particularly limited so far as it has such a chemical bond. Examples thereof include fluorocarbon resins (for example, polyvinylidene fluoride, etc.); and mixtures of carboxymethyl cellulose and a rubbery resin (for example, a styrene butadiene rubber, an acrylic rubber, a butadiene rubber, an acrylonitrile butadiene rubber, etc.).

FIG. 3 shows enlargedly a part of the negative electrode 21 shown in FIG. 1. The porous protective film layer 21C containing an inorganic filler 212 is provided on the surface of the negative electrode mixture layer 21B containing a negative electrode active material 211 in the negative electrode 21.

As the porous protective film layer, for example, a coating film obtained by dispersing an inorganic filler material in a solvent together with a second resin material and a surfactant to prepare a slurry for forming a porous protective film layer and coating this slurry for forming a porous protective film layer on a negative electrode mixture layer can be used.

The reason why a porous material is used as the protective film resides in the matter that an original function of the electrode, namely a reaction with an electrolyte ion in the electrolytic solution is not impaired.

A thickness of this porous protective film layer is preferably in the range of from 0.1 to 20 μm. When the thickness of the thickness of the protective film layer is less than 0.1 μm, there is a concern that the protective effect is insufficient so that a physical internal short circuit cannot be sufficiently prevented from occurring.

Also, when the thickness of the porous protective film layer exceeds 20 μm, there is a concern that the porous protective film layer disturbs a reaction of the electrode with an ion in the electrolytic solution, thereby deteriorating the battery performance.

### (Positive Electrode)

The positive electrode 22 has, for example, a structure in which a positive electrode mixture layer 22B containing a positive electrode active material and a first resin is provided on the both surfaces of a positive electrode collector 22A having a pair of opposing surfaces to each other.

Though illustration is omitted, the positive electrode mixture layer 22B may be provided only on one surface of the positive electrode collector 22A.

The positive electrode collector 22A is configured of a metal foil, for example, an aluminum foil, etc.

Also, the positive electrode mixture layer 22B is configured to include a positive electrode active material and a first resin and may include a conductive agent, for example, ketjen black, etc. as the need arises.

Here, examples of the positive electrode active material include a positive electrode material capable of intercalating and deintercalating lithium.

Any known positive electrode materials can be used as the positive electrode active material so far as they are able to intercalate and deintercalate lithium and contain a sufficient amount of lithium.

Specifically, it is preferred to use a complex metal oxide composed of lithium and a transition metal, which is represented by the general formula: LiMO₂ (wherein M contains at least one member of Co, Ni, Mn, Fe, Al, V and Ti), a lithium-containing intercalation compound or the like.

In addition to this, LiₐMX_{b} (wherein M represents at least one member selected among transition metals; X is selected among S, Se and PO₄; 0<a; and b represents an integer) can also be used.

In particular, it is preferred to use a lithium complex oxide represented by LiₓMIO₂ or Li_{y}MII2O₄ as the positive electrode active material because a high voltage can be generated, and an energy density can be increased.

In the foregoing composition formulae, MI represents at least one transition metal element, and preferably at least one member of cobalt (Co) and nickel (Ni).

MII represents at least one transition metal element, and preferably manganese (Mn). Also, values of x and y vary depending upon the charge and discharge state of the battery and usually fall within the range of 0.05 or more and not more than 1.10.

Specific examples of such a lithium complex oxide include LiCoO₂, LiNiO₂, LiNi_{z}Co_{1-z}O₂ (wherein 0<z<1) and LiMn₂O₄.

As the first resin, the same resins as those in the negative electrode can be used. The kind of the resin may be the same or different.

### (Separator)

As the separator 24, a porous film made of a polyolefin, for example, polypropylene, polyethylene, etc. can be suitably used.

The polyolefin-made porous film is excellent in electrochemical stability so that it is excellent in an effect for preventing a short circuit from occurring and is able to devise to enhance the stability of the battery due to a shutdown effect. For example, polypropylene is able to obtain a shutdown effect within the range of from 150 to 170° C. On the other hand, polyethylene is able to obtain a shutdown effect within the range of from 100 to 160° C.

Also, the separator may have a structure in which two or more kinds of such porous films are laminated.

For example, the structure is a structure having a substrate layer and a surface layer provided on the surface of the substrate layer opposing to the positive electrode side or the both surfaces thereof, in which the substrate layer is configured of polyethylene, whereas the surface layer is configured of polypropylene. Furthermore, the surface layer can also be configured of a porous film made of a fluorocarbon resin such as polyvinylidene fluoride and polytetrafluoroethylene.

For example, a thickness of the separator is preferably in the range of 10 μm or more and not more than 300 μm, and more preferably in the range of 15 μm or more and not more than 30 μm. This is because when the thickness of the separator is too thin, there is a concern that a short circuit is generated, whereas when the thickness of the separator is too thick, the filling amount of the positive electrode material is lowered.

### (Non-Aqueous Electrolyte)

The non-aqueous electrolytic solution which is an example of the non-aqueous electrolyte is, for example, one in which a lithium salt is dissolved as an electrolyte salt in a non-aqueous solvent.

As the non-aqueous solvent, organic solvents such as propylene carbonate, ethylene carbonate, diethyl carbonate, dimethyl carbonate, methylethyl carbonate, γ-butyl lactone, tetrahydrofuran, 1,2-dimethoxyethane, 1,3-dioxolan, 4-methyl-1,3-dioxolan, diethyl ether, sulforane, methylsulforane, acetonitrile and propionitrile are preferable. Any one kind or mixtures of two or more kinds thereof are used.

Examples of the lithium salt include LiCl, LiClO₄, LiAsF₆, LiPF₆, LiBF₄, LiB(C₆H₅)₄, LiBr, CH₃SO₃Li, CF₃SO₃Li and N(CₙF_{2n|1}SO₂)₂Li. Any one kind or mixtures of two or more kinds thereof are used. Above all, it is preferable that LiPF₆ is chiefly used.

### (1-2) Manufacturing Method of Secondary Battery:

The non-aqueous electrolyte secondary battery having the foregoing configuration can be, for example, manufactured in the following manner.

For example, a negative electrode active material and a first resin material are mixed to prepare a negative electrode mixture, and this negative electrode mixture is dispersed in a solvent such as N-methyl-2-pyrrolidone and water to form a slurry for forming a negative electrode mixture layer.

Here, examples of the first resin material which can be applied include usual type resins such as fluorocarbon resins (for example, polyvinylidene fluoride, etc.) and mixtures of carboxymethyl cellulose and a rubbery resin (for example, a styrene butadiene rubber, an acrylic rubber, a butadiene rubber, an acrylonitrile butadiene rubber, etc.); and crosslinking type resins thereof. Examples of the crosslinking type resin include resins obtained by allowing a resin obtained by copolymerizing a hydroxyl group, a carboxyl group, etc. in a resin (for example, polyvinylidene fluoride, etc.) with an inorganic filler material or a silane coupling agent as described below or the like, thereby introducing a structural unit capable of forming a chemical bond including the structure represented by the foregoing general formula (3) or (4). As a binder to be used herein, specifically, one obtained by modifying a polyvinylidene fluoride resin with maleic acid, or the like can be used. Of the crosslinking type resins, those in which a chemical bond including the structure represented by the foregoing general formula (3) or (4) is formed by heating are a thermal crosslinking type resin.

Subsequently, the obtained slurry for forming a negative electrode mixture layer is coated on a negative electrode collector, and after drying the solvent, the resulting negative electrode collector is subjected to compression molding by a roll press or the like, thereby forming a negative electrode mixture layer or a negative electrode mixture layer precursor.

Also, an inorganic filler material, a second resin material and water are mixed to form a slurry for forming a porous protective film layer. A silane coupling agent may be further added.

Here, examples of the inorganic filler material include colloidal silica, colloidal alumina and colloidal zirconia. These materials may be used singly or in admixture.

Also, a crosslinking type resin the same as in the foregoing first resin, in particular, a thermal crosslinking type resin can be applied as the second resin material.

Furthermore, the silane coupling agent is added for the purpose of treating the surface of the inorganic filler. In the silane coupling agent, a functional group which is reactive with the first resin material or second resin material is aligned outside and reacts to form a siloxane bond (—Si—O—Si—), whereby good adhesion can be kept. As a result, the silane coupling agent is not particularly limited so far as it has a polar group which is reactive with the first resin material or second resin material and the inorganic filler material, and silane coupling agents which have hitherto been known can be applied. Specific examples thereof include silane coupling agents having an epoxy group, a sulfide group, a mercapto group or an amino group. The addition amount of the silane coupling agent is preferably from 0.1 to 1.0% by mass. When the addition amount of the silane coupling agent is too large, there is a concern that the stability of the system is lowered due to an alcohol which is generated by hydrolysis. Also, a silane coupling agent having an amino group is desirable from the viewpoint that it is able to stabilize a sol solution. By forming a siloxane bond, an enhancement of the chemical resistance or flexibility can be expected, and an enhancement of the effect for suppressing or preventing the occurrence of breakage or separation of the porous protective film layer can be expected.

The Si—O bond can be confirmed by an absorption spectrum at from 1,110 to 830 cm⁻¹ by using FT-IR.

Moreover, in the slurry for forming a porous protective film layer, the surface of a colloid particle forms an electrical double layer by a hydroxyl group, etc. and is stabilized by repulsion between the particles. By forming such a colloid solution, properties of the slurry can be stabilized, whereby long-term storage properties are enhanced. Also, by enhancing an affinity between the colloid particle and the second resin material by the hydroxyl group, a binding force between particles is enhanced. As a water-dispersed colloid solution of the inorganic filler material, it is desirable to use a relatively large sol having a particle size of from 20 to 200 nm. When the particle size is smaller than the foregoing range, there is a concern that clogging is generated on the surface of the negative electrode mixture layer. Also, there is a possibility that permeability of the electrolytic solution is lowered due to a lowering of air permeability of the porous protective film layer at the time of fabrication, whereby a discharge capacity retention rate of the battery is lowered. Also, when the particle size is larger than the foregoing range, there is a possibility that the stability of the colloid solution becomes worse, whereby sedimentation or cohesion of the particle occurs.

Subsequently, the obtained slurry for forming a porous protective film layer is coated on the obtained negative electrode mixture layer or negative electrode mixture layer precursor, and the solvent is dried, thereby forming a porous protective film layer.

In such a step, in drying the solvent, when heating at, for example, 100° C. or higher is carried out, a chemical bond including the structure represented by the foregoing general formula (1) or (2) is formed. Also, in the case of applying, as the first resin material, a crosslinking type resin, in particular, a thermal crosslinking type resin, a chemical bond including the structure represented by the foregoing general formula (3) or (4) is formed.

Also, in such a step, the second resin material in the slurry for forming a porous protective film layer causes chemical bonding in the vicinity of a contact interface between the inorganic filler materials each other or a contact interface between the inorganic filler material and the negative electrode mixture layer, whereby a stable and firm porous protective film layer is obtained.

Subsequently, for example, a positive electrode active material and a first resin material are mixed to prepare a positive electrode mixture, and this positive electrode mixture is dispersed in a solvent such as N-methyl-2-pyrrolidone to form a slurry for forming a positive electrode mixture layer. Subsequently, the obtained slurry for forming a positive electrode mixture layer is coated on a positive electrode collector, and after drying the solvent, the resulting positive electrode collector is subjected to compression molding by a roll press or the like, thereby forming a positive electrode mixture layer.

There is thus prepared a positive electrode.

Subsequently, a negative electrode lead is installed in the negative electrode collector by means of welding, etc., and a positive electrode lead is also installed in the positive electrode collector by means of welding, etc. Thereafter, the negative electrode and the positive electrode are wound via a separator; a tip of the negative electrode lead is welded to a battery can, and a tip of the positive electrode lead is welded to a safety valve mechanism; and the wound negative electrode and positive electrode are interposed by a pair of insulating plates and housed in the inside of the battery can. After housing the negative electrode and positive electrode in the inside of the battery can, a non-aqueous electrolytic solution is injected into the inside of the battery can and impregnated in the separator. Thereafter, a battery lid, a safety valve mechanism and a positive temperature coefficient element are fixed to an open end of the battery can via a sealing gasket by caulking.

There is thus completed a non-aqueous electrolyte secondary battery shown in FIG. 1.

### (2) Embodiment 2

### (2-1) Configuration of Non-Aqueous Electrolyte Secondary Battery:

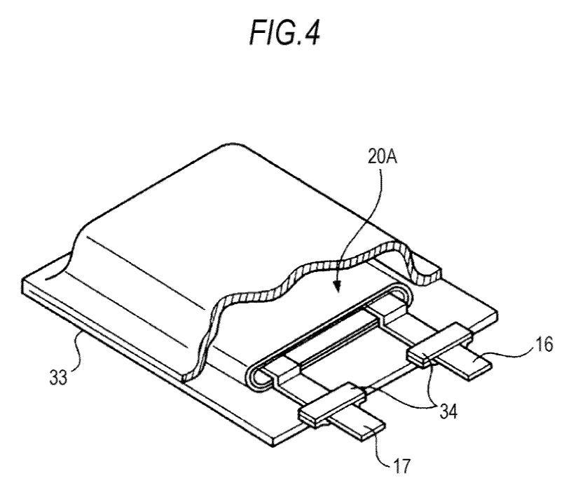

FIG. 4 is a perspective view showing an example of a configuration of a non-aqueous electrolyte secondary battery according to Embodiment 2 of the present invention. This non-aqueous electrolyte secondary battery is of a so-called laminate type.

This non-aqueous electrolyte secondary battery is one in which a battery element 20A having a negative electrode lead 16 and a positive electrode lead 17 installed therein is housed in the inside of a laminated film 33 which is an example of the exterior member and is able to realize downsizing, weight saving and thinning.

The negative electrode lead 16 and the positive electrode lead 17 are each led out in, for example, the same direction from the inside toward the outside of the laminated film 33.

The negative electrode lead 16 and the positive electrode lead 17 are each configured of a metal material, for example, aluminum (Al), copper (Cu), nickel (Ni), stainless steel, etc. and formed in a thin plate state or network state.

The laminated film 33 is configured of, for example, a rectangular aluminum laminated film obtained by sticking a nylon film, an aluminum foil and a polyethylene film in this order.

For example, the aluminum laminated film is disposed such that the polyethylene film side and the battery element 20A are opposed to each other, and the respective outer edges are brought into intimate contact with each other by means of fusion or with an adhesive. A contact film 34 is inserted between the laminated film and each of the negative electrode lead 16 and the positive electrode lead 17 for the purpose of preventing invasion of the outside air.

The contact film 34 is configured of a material having adhesion to the negative electrode lead 16 and the positive electrode lead 17, for example, polyolefin resins such as polyethylene, polypropylene, modified polyethylene and modified polypropylene.

The laminated film 33 may be configured of a laminated film having other structure, a polymer film such as polypropylene or a metal film in place of the foregoing aluminum laminated film.

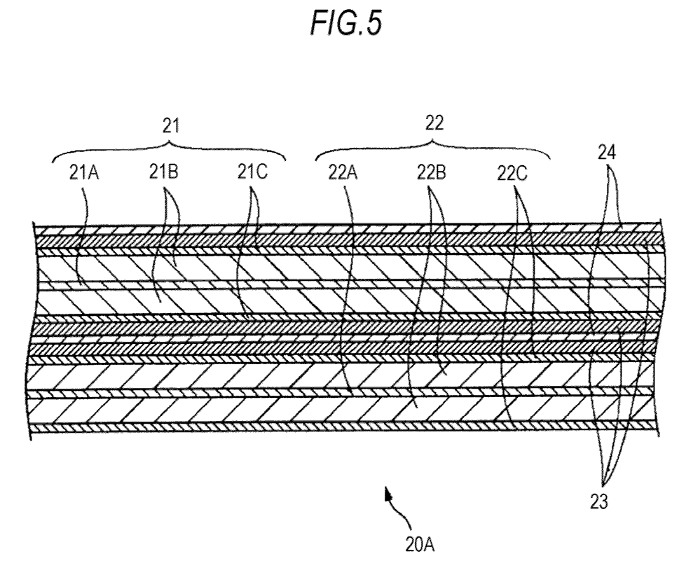

FIG. 5 shows enlargedly a part of the battery element 20A shown in FIG. 4.

The battery element 20A is one prepared by laminating a negative electrode 21 and a positive electrode 22 via a non-aqueous electrolyte layer 23 and a separator 24 and winding the laminate, and an outermost peripheral part thereof is protected by a protective tape.

The negative electrode 21 has a structure in which a negative electrode mixture layer 21B is provided on one or both of the surfaces of a negative electrode collector 21A. A porous protective film 21C is provided on one or both of the surfaces of this negative electrode mixture layer 21B.

The positive electrode 22 has a structure in which a positive electrode mixture layer 22B is provided on one or both of the surfaces of a positive electrode collector 22A, and the negative electrode mixture layer 21B and the positive electrode mixture layer 22B are disposed opposing to each other. A porous protective film 22C is provided on one or both of the surfaces of this positive electrode mixture layer 22B.

In this embodiment, while the case where the porous protective film is provided on both the surface of the negative electrode mixture layer and the surface of the positive electrode mixture layer is explained as an example, the porous protective film may be provided on either one of the surface of the negative electrode mixture layer or the surface of the positive electrode mixture layer.

The configurations of the negative electrode collector 21A, the negative electrode mixture layer 21B, the porous protective film 21C, the positive electrode collector 22A, the positive electrode mixture layer 22B, the porous protective film 22C and the separator 24 are the same as those in Embodiment 1, respectively.

The non-aqueous electrolyte layer 23 contains a non-aqueous electrolytic solution and a polymer compound which will serve as a holding body for holding this electrolytic solution therein and forms a so-called gel.

The non-aqueous electrolyte layer 23 in a gel form is preferable because not only high ionic conductivity can be obtained, but liquid leakage of the battery can be prevented from occurring.

The configuration of the non-aqueous electrolytic solution (namely, a non-aqueous solvent, an electrolyte salt and the like) is the same as in the non-aqueous electrolyte secondary battery according to the foregoing Embodiment 1.

Examples of the polymer compound include polyacrylonitrile, polyvinylidene fluoride, a copolymer of polyvinylidene fluoride and polyhexafluoropropylene, polytetrafluoroethylene, polyhexafluoropropylene, polyethylene oxide, polypropylene oxide, polyphosphazene, polysiloxane, polyvinyl acetate, polyvinyl alcohol, polymethyl methacrylate, polyacrylic acid, polymethacrylic acid, styrene-butadiene rubbers, nitrile-butadiene rubbers, polystyrene and polycarbonates.

In particular, taking into account the electrochemical stability, polyacrylonitrile, polyvinylidene fluoride, polyhexafluoropropylene, polyethylene oxide and so on are preferable.

### (2-2) Manufacturing Method of Secondary Battery:

The non-aqueous electrolyte secondary battery having the foregoing configuration can be, for example, manufactured in the following manner.

First of all, a precursor solution containing a non-aqueous solvent, an electrolyte salt, a polymer compound and a mixed solvent is coated on each of a negative electrode and a positive electrode, and the mixed solvent is vaporized to form a non-aqueous electrolyte layer.

Thereafter, a negative electrode lead is installed in an end of a negative electrode collector by means of welding, etc., and a positive electrode lead is also installed in an end of a positive electrode collector by means of welding, etc.

Subsequently, the negative electrode and the positive electrode each having the non-aqueous electrolyte layer formed thereon are laminated via a separator to form a laminate. This laminate is then wound in a longitudinal direction thereof, and a protective tape is allowed to adhere to the outermost peripheral part to form a battery element.

Finally, for example, the battery element is interposed within a laminated film, and the outer edges of the laminated film are brought into intimate contact with each other by means of heat fusion, etc. and sealed.

On that occasion, a contact film is inserted between each of the negative electrode lead and the positive electrode lead and the laminated film.

There is thus obtained the non-aqueous electrolyte secondary battery shown in FIG. 4.

Also, this non-aqueous electrolyte secondary battery may be prepared in the following manner.

First of all, as described previously, a negative electrode and a positive electrode are prepared; a negative electrode lead and a positive electrode lead are installed in the negative electrode and the positive electrode, respectively; the negative electrode and the positive electrode are then laminated via a separator and wound; and a protective tape is allowed to adhere to the outermost peripheral part, thereby forming a wound electrode body serving as a precursor of a battery element.

Subsequently, this wound electrode body is interposed within a laminated film, and the outer edges exclusive of one side are heat fused to form a bag, which is then housed in the inside of the laminated film.

Subsequently, a composition for forming a non-aqueous electrolyte layer containing a non-aqueous solvent, an electrolyte salt, a monomer as a raw material of the polymer compound, a polymerization initiator and optionally other materials such as a polymerization inhibitor is prepared and injected into the inside of the laminated film in a bag form.

After injecting the composition for forming a non-aqueous electrolyte layer, an opening of the laminated film 33 formed in a bag form is heat fused in a vacuum atmosphere and hermetically sealed.

Subsequently, the monomer is polymerized upon application of heat to form a polymer compound, thereby forming a non-aqueous electrolyte layer in a gel form.

There is thus obtained the non-aqueous electrolyte secondary battery shown in FIG. 4.

The action and effect of this Embodiment 2 are the same as those in the foregoing Embodiment 1.

### EXAMPLES

Embodiments according are hereunder described in more detail with reference to the following Examples and Comparative Examples.

Specifically, operations described in each of the following Examples and Comparative Examples were carried out to prepare the non-aqueous electrolyte secondary battery shown in FIG. 1, and its performance was evaluated.

### Example 1

### <Preparation of Porous Protective Film Layer-Provided Negative Electrode>

First of all, 95.5 parts by mass of a granular artificial graphite powder (BET specific surface area: 0.58 m²/g), which is an example of graphite, as a negative electrode active material, 3 parts by mass of polyvinylidene fluoride as a first resin material and 1.5 parts by mass of a vapor growth carbon fiber (VGCF, manufactured by Showa Denko K.K.) as a conductive agent were mixed to prepare a negative electrode mixture. This negative electrode mixture was dispersed in N-methyl-2-pyrrolidone to prepare a slurry for forming a negative electrode mixture layer.

Subsequently, this slurry for forming a negative electrode mixture layer was coated on the both surfaces of a strip-shaped copper foil (thickness: 12 μm) serving as a negative electrode collector and dried, and the resulting negative electrode collector was subjected to compression molding by a press machine, thereby preparing a strip-shaped negative electrode.

Furthermore, 15 parts by mass of colloidal silica (average particle size: 0.1 μm) as an inorganic filler material, 1.2 parts by mass of carboxymethyl cellulose and 1 part by mass of a styrene butadiene rubber as a second resin material and 82.7 parts by mass of ion exchanged water were mixed with manual stirring; 0.1 parts by mass of sodium dodecyl sulfate as a surfactant was further added; and the mixture was mixed with stirring at 3,000 rpm for 30 minutes, thereby preparing a slurry for forming a porous protective film layer.

Thereafter, this slurry for forming a porous protective film layer was coated on the negative electrode mixture layer of the thus prepared negative electrode in a thickness of 3 μm with respect to the porous protective film layer, followed by drying in a thermostat at 100° C. to form a porous protective film layer. There was thus prepared a porous protective film layer-provided negative electrode. Furthermore, a nickel-made lead was installed in the strip-shaped copper foil.

### <Preparation of Positive Electrode>

Subsequently, 95.5 parts by mass of LiCoO₂ as a positive electrode active material, 3 parts by mass of polyvinylidene fluoride as a first resin material and 1.5 parts by mass of ketjen black as a conductive agent were mixed to prepare a positive electrode mixture. This positive electrode mixture was dispersed in N-methyl-2-pyrrolidone to prepare a slurry for forming a positive electrode mixture layer.

Subsequently, this slurry for forming a positive electrode mixture layer was coated on the both surfaces of a strip-shaped aluminum foil having a thickness of 15 μm and dried, followed by compression molding by a press machine. There was thus prepared a strip-shaped positive electrode. Furthermore, an aluminum-made lead was installed in the strip-shaped aluminum foil.

### <Preparation of Non-Aqueous Electrolyte Secondary Battery>

Subsequently, the prepared strip-shaped negative electrode and strip-shaped positive electrode were laminated via a strip-shaped microporous polypropylene film having a thickness of 18 μm as a separator in the order of the negative electrode, the separator, the positive electrode and the separator, thereby preparing a laminated electrode body having a four-layered structure. This laminated electrode body was wound a number of times in a helical type along its length direction such that the negative electrode was faced inwardly, and an end of the separator located on the outermost periphery was further fixed by a tape, thereby preparing a wound electrode body. This wound electrode body had an outer diameter of about 17.4 mm.

Subsequently, the prepared wound electrode body was housed in a nickel-plated iron-made battery can, and an insulating plate was placed on each of the upper and lower surfaces of the wound electrode body.

Subsequently, in order to carry out current collection of the negative electrode, the nickel-made negative electrode lead was led out from the strip-shaped copper foil and welded to the battery can. Also, in order to carry out current collection of the positive electrode, the aluminum-made lead was led out from the strip-shaped aluminum foil and welded to the battery can.

Furthermore, 4.4 g of a non-aqueous electrolytic solution having lithium hexafluorophosphate (LiPF₆) in an equal volume mixed solvent of propylene carbonate and diethyl carbonate was injected in the battery can having the wound electrode body housed therein and impregnated in the wound electrode body.

Thereafter, a battery lid was fixed by caulking the battery can via an insulating sealing gasket, thereby keeping the air tightness within the battery. There was thus obtained a non-aqueous electrolyte secondary battery of this Example 1 (cylinder type, diameter: 18 mm, height: 65 mm).

### Example 2

A non-aqueous electrolyte secondary battery of this Example 2 was obtained by repeating the same operations as in Example 1, except that a slurry for forming a porous protective film layer obtained by mixing 15 parts by mass of colloidal alumina (average particle size: 0.1 μm) as an inorganic filler material, 1.2 parts by mass of carboxymethyl cellulose and 1 part by mass of a styrene butadiene rubber as a second resin material and 82.7 parts by mass of ion exchanged water with manual stirring, further adding 0.1 parts by mass of sodium dodecyl sulfate as a surfactant and mixing the mixture with stirring at 3,000 rpm for 30 minutes was used in preparing a porous protective film layer-provided negative electrode.

### Example 3

A non-aqueous electrolyte secondary battery of this Example 3 was obtained by repeating the same operations as in Example 1, except that a slurry for forming a porous protective film layer obtained by mixing 15 parts by mass of colloidal zirconia (average particle size: 0.1 μm) as an inorganic filler material, 1.2 parts by mass of carboxymethyl cellulose and 1 part by mass of a styrene butadiene rubber as a second resin material and 82.7 parts by mass of ion exchanged water with manual stirring, further adding 0.1 parts by mass of sodium dodecyl sulfate as a surfactant and mixing the mixture with stirring at 3,000 rpm for 30 minutes was used in preparing a porous protective film layer-provided negative electrode.

### Example 4

A non-aqueous electrolyte secondary battery of this Example 4 was obtained by repeating the same operations as in Example 1, except that a slurry for forming a porous protective film layer obtained by mixing 15 parts by mass of colloidal silica (average particle size: 0.1 μm) as an inorganic filler material, 1.2 parts by mass of carboxymethyl cellulose and 1 part by mass of a styrene butadiene rubber as a second resin material and 81.7 parts by mass of ion exchanged water with manual stirring, further adding 0.1 parts by mass of sodium dodecyl sulfate as a surfactant and 1 part by mass of a silane coupling agent (3-aminopropyltrimethoxysilane) and mixing the mixture with stirring at 3,000 rpm for 30 minutes was used in preparing a porous protective film layer-provided negative electrode.

### Example 5

A non-aqueous electrolyte secondary battery of this Example 5 was obtained by repeating the same operations as in Example 1, except that a slurry for forming a porous protective film layer obtained by mixing 15 parts by mass of colloidal alumina (average particle size: 0.1 μm) as an inorganic filler material, 1.2 parts by mass of carboxymethyl cellulose and 1 part by mass of a styrene butadiene rubber as a second resin material and 81.7 parts by mass of ion exchanged water with manual stirring, further adding 0.1 parts by mass of sodium dodecyl sulfate as a surfactant and 1 part by mass of a silane coupling agent (3-aminopropyltrimethoxysilane) and mixing the mixture with stirring at 3,000 rpm for 30 minutes was used in preparing a porous protective film layer-provided negative electrode.

### Example 6

A non-aqueous electrolyte secondary battery of this Example 6 was obtained by repeating the same operations as in Example 1, except that a slurry for forming a porous protective film layer obtained by mixing 15 parts by mass of colloidal zirconia (average particle size: 0.1 μm) as an inorganic filler material, 1.2 parts by mass of carboxymethyl cellulose and 1 part by mass of a styrene butadiene rubber as a second resin material and 81.7 parts by mass of ion exchanged water with manual stirring, further adding 0.1 parts by mass of sodium dodecyl sulfate as a surfactant and 1 part by mass of a silane coupling agent (3-aminopropyltrimethoxysilane) and mixing the mixture with stirring at 3,000 rpm for 30 minutes was used in preparing a porous protective film layer-provided negative electrode.

### Comparative Example 1

A non-aqueous electrolyte secondary battery of this Comparative Example 1 was obtained by repeating the same operations as in Example 1, except that a porous protective film layer was not formed on the surface of the negative electrode mixture layer.

### Comparative Example 2

A non-aqueous electrolyte secondary battery of this Comparative Example 2 was obtained by repeating the same operations as in Example 1, except that a slurry for forming a porous protective film layer obtained by mixing 15 parts by mass of alumina (average particle size: 0.1 μm) as an inorganic filler material, 1.2 parts by mass of carboxymethyl cellulose and 1 part by mass of a styrene butadiene rubber as a second resin material and 82.7 parts by mass of ion exchanged water with manual stirring, further adding 0.1 parts by mass of sodium dodecyl sulfate as a surfactant and mixing the mixture with stirring at 3,000 rpm for 30 minutes was used in preparing a porous protective film layer-provided negative electrode.

### Comparative Example 3

A non-aqueous electrolyte secondary battery of this Comparative Example 3 was obtained by repeating the same operations as in Example 1, except that a slurry for forming a porous protective film layer obtained by mixing 15 parts by mass of alumina (average particle size: 0.1 μm) as an inorganic filler material, 1.2 parts by mass of carboxymethyl cellulose and 1 part by mass of a styrene butadiene rubber as a second resin material and 81.7 parts by mass of ion exchanged water with manual stirring, further adding 0.1 parts by mass of sodium dodecyl sulfate as a surfactant and 1 part by mass of a silane coupling agent (3-aminopropyltrimethoxysilane) and mixing the mixture with stirring at 3,000 rpm for 30 minutes was used in preparing a porous protective film layer-provided negative electrode.

### [Performance Evaluation]

### (Observation of Breakage and Separation of Porous Protective Film Layer)

With respect to each of the thus prepared non-aqueous electrolyte secondary batteries, charge and discharge in which constant current-constant voltage charge of 500 mA was carried out at 40° C. for 14 hours until the voltage reached an upper limit of 4.2 V, and subsequently, constant current discharge of 500 mA was carried out to a cut-off voltage of 3.0 V were carried out in 200 cycles.

After 200 cycles, the non-aqueous electrolyte secondary battery was taken apart, and the state of breakage and separation of the porous protective film layer was observed by using a scanning electron microscope (SEM).

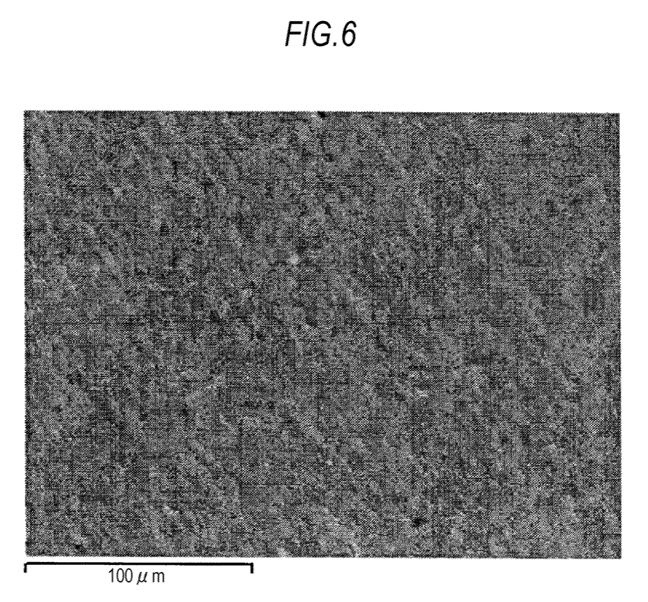

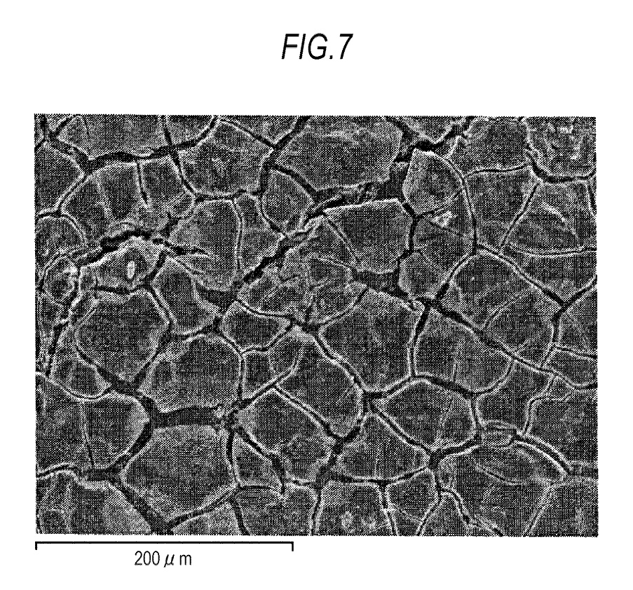

The obtained results are shown in Table 1. In Table 1, the result in which breakage or separation occurred in the porous protective film layer is designated as “bad”; and the result in which neither breakage nor separation occurred in the porous protective film layer is designated as “good”. Also, an SEM photograph of the porous protective film layer in Example 1 is shown in FIG. 6. Furthermore, an SEM photograph of the porous protective film layer in Comparative Example 2 is shown in FIG. 7.

### (Rate of Occurrence of Short Circuit)

With respect to each of the thus prepared batteries, a fine Ni metal piece was put in the battery, and a rate of occurrence of a physical internal short circuit was examined in the following manner. First of all, immediately after the preparation of a battery, the battery was subjected to initial charge and then allowed to stand for one week.

After allowing it to stand for one week, an open circuit voltage was measured. The case where this voltage was not more than a reference value was determined as “presence of an internal short circuit”. A rate of occurrence of internal short circuit (%) [=(the number of batteries to be determined as “presence of an internal short circuit”)/(the total number of evaluated batteries)×100] was obtained on the basis of the result of this determination.

The obtained results are also shown in Table 1.

TABLE 1

| | | Presence or | Breakage and | Rate of |
|---|---|---|---|---|
| | Kind of | absence of | separation of | occurrence |
| | inorganic | silane | porous | of internal |
| | filler | coupling | protective | short circuit |
| | material | agent | film layer | (%) |
| Example 1 | Colloidal | No | Good | 2.5 |
| | silica | | | |
| Example 2 | Colloidal | No | Good | 3.1 |
| | alumina | | | |
| Example 3 | Colloidal | No | Good | 2.1 |
| | zirconia | | | |
| Example 4 | Colloidal | Yes | Good | 2.9 |
| | silica | | | |
| Example 5 | Colloidal | Yes | Good | 2.7 |
| | alumina | | | |
| Example 6 | Colloidal | Yes | Good | 2.4 |
| | zirconia | | | |
| Comparative | — | — | — | 14.3 |
| Example 1 | | | | |
| Comparative | Alumina | No | Bad | 8.9 |
| Example 2 | | | | |
| Comparative | Alumina | Yes | Bad | 5.3 |
| Example 3 | | | | |

As clear from Table 1, in Examples 1 to 6 which fall within the scope of the present invention, since a porous protective film layer using an inorganic filler material such as colloidal silica, colloidal alumina or colloidal zirconia was formed, it is noted that the breakage or separation of the porous protective film layer can be suppressed or prevented from occurring as compared with Comparative Examples 2 and 3 which fall outside the scope of the present invention, in which a porous protective film layer was formed without using such an inorganic filler material.

Also, it is noted that in Examples 1 to 6 which fall within the scope of the present invention, the rate of occurrence of an internal short circuit is lowered as compared with Comparative Examples 1 to 3 which fall outside the scope of the present invention.

In Examples 1 to 3, since the hydroxyl group which colloidal silica, colloidal alumina or colloidal zirconia or the like has reacts with the hydroxyl group which the styrene butadiene rubber has in a terminal thereof or the hydroxyl group which carboxymethyl cellulose has, thereby forming a chemical bond including the structure represented by the foregoing general formula (1), the breakage or separation could be prevented from occurring. Also, in the case where the hydroxyl group which colloidal silica, colloidal alumina or colloidal zirconia or the like has reacts with the hydroxyl group which polyvinylidene fluoride has in a terminal thereof, thereby forming a chemical bond including the structure represented by the foregoing general formula (3), it is estimated that the breakage or separation could be prevented thereby from occurring.

Also, in Examples 4 to 6, since the hydroxyl group which colloidal silica, colloidal alumina or colloidal zirconia or the like reacts with the silane coupling agent and the hydroxyl group which the styrene butadiene rubber has in a terminal thereof or the hydroxyl group which carboxymethyl cellulose has, thereby forming a chemical bond including the structure represented by the foregoing general formula (2), the breakage or separation could be prevented from occurring. Also, in the case where the hydroxyl group which colloidal silica, colloidal alumina or colloidal zirconia or the like has reacts with the silane coupling agent and the hydroxyl group which the polyvinylidene fluoride has in a terminal thereof, thereby forming a chemical bond including the structure represented by the foregoing general formula (4), it is estimated that the breakage or separation could be prevented thereby from occurring. There may be a possibility that a chemical bond including the structure represented by the foregoing general formula (1) or (3) is formed.

In the foregoing working examples, while the case of forming a porous protective film only in a negative electrode has been described, the same effects can also be obtained in the case of forming a porous protective film only in a positive electrode, or in the case of forming a porous protective film on both a positive electrode and a negative electrode.

Also, for example, in the foregoing embodiments and working examples, while the case of using, as a non-aqueous electrolyte, a non-aqueous electrolytic solution or a non-aqueous electrolyte in a gel form has been described, the present invention can also be applied in the case of using a polymer solid electrolyte containing a single body of a conductive polymer compound or a mixture thereof.

Specific examples of the conductive polymer compound which is contained in the polymer solid electrolyte include silicon polymers, acrylic polymers, acrylonitrile polymers, polyphosphazene-modified polymers, polyethylene oxide, polypropylene oxide, fluorocarbon based polymers, complex polymers of these compounds, crosslinked polymers and modified polymers. In particular, examples of the foregoing fluorocarbon based polymer include poly(vinylidene fluoride), poly(vinylidene fluoride-co-hexafluoropropylene), poly(vinylidene fluoride-co-tetrafluoroethylene) and poly(vinylidene fluoride-co-trifluoroethylene).

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A porous protective film layer-provided electrode comprising:
an electrode having a collector and an electrode mixture layer disposed on the surface of the collector, the mixture layer containing an electrode active material and a first resin; and
a porous protective film layer disposed on the surface of the electrode mixture layer, the film layer containing an inorganic filler and a second resin, wherein
a chemical bond including a structure represented by the following general formula (1) or (2) is present between the inorganic filler and the second resin:
—O— (1)
—O—Si— (2).

2. The porous protective film layer-provided electrode according to claim 1, wherein
a chemical bond including a structure represented by the following general formula (3) or (4) is present between the first resin and the inorganic filler:
—O— (3)
—O—Si— (4).

3. A non-aqueous electrolyte secondary battery comprising:
an electrode having a collector and an electrode mixture layer disposed on the surface of the collector, the mixture layer containing an electrode active material and a first resin;
a porous protective film layer disposed on the surface of the electrode mixture layer, the film layer containing an inorganic filler and a second resin;
a non-aqueous electrolyte; and
a separator, wherein
a chemical bond including a structure represented by the following general formula (1) or (2) is present between the inorganic filler and the second resin:
—O— (1)
—O—Si— (2).

4. A method for manufacturing a porous protective film layer-provided electrode, the method comprising:
(a) coating a slurry for forming an electrode mixture layer containing an electrode active material and a first resin material on a collector and drying to form an electrode mixture layer or an electrode mixture layer precursor; and
(b) coating a slurry for forming a porous protective film layer containing an inorganic filler material and a second resin material on the obtained electrode mixture layer or electrode mixture layer precursor and drying to form a porous protective film layer.

5. The method for manufacturing a porous protective film layer-provided electrode according to claim 4, wherein
the first resin material contains a crosslinking type resin material; the inorganic filler material contains at least one member selected from the group consisting of colloidal silica, colloidal alumina and colloidal zirconia; and the second resin material contains a crosslinking type resin material.

6. A method for manufacturing a porous protective film layer-provided electrode, the method comprising:
(a) a coating a slurry for forming an electrode mixture layer containing an electrode active material and a first resin material on a collector and drying to form an electrode mixture layer or an electrode mixture layer precursor; and
(b) coating a slurry for forming a porous protective film layer containing an inorganic filler material, a second resin material and a silane coupling agent on the obtained electrode mixture layer or electrode mixture layer precursor and drying to form a porous protective film layer.

7. The method for manufacturing a porous protective film layer-provided electrode according to claim 6, wherein
the first resin material contains a crosslinking type resin material; the inorganic filler material contains at least one member selected from the group consisting of colloidal silica, colloidal alumina and colloidal zirconia; and the second resin material contains a crosslinking type resin material.
